(19) United States
(12) Patent Application Publication
(10) Pub. No.: US 2003/0046846 A1
(43) Pub. Date: Mar. 13, 2003

(54) Indicia clip device

(76) Inventor: Lisa Goodman, Los Angeles, CA (US)

Correspondence Address: SONNENSCHEIN NATH & ROSENTHAL, P.O. BOX 061080, WACKER DRIVE STATION, CHICAGO, IL, 60606-1080, US

(21) Appl. No.: 09/950,256

(22) Filed: Sep. 10, 2001

(51) Int. Cl. G09F 3/20

(52) U.S. Cl. 40/658

(57) ABSTRACT

A clip device with an indicia display. Identifying a group of documents is enhanced by applying indicia to the group of documents. An indicia member having an indicia area is positioned above a base member. A biasing element connected to the base member biasing elements the indicia member and the base member together hold the group of documents. An indicia display is located on the indicia area. The indicia display is configured to receive and display interchangeable indicia wherein the indicia display has a transparent pocket and removable tab.

### BACKGROUND OF THE INVENTION

The present invention relates to a device to display indicia. In particular, the invention relates to methods and other accommodations to display indicia indicating information about a group of documents which are held together by the invention.

Efficiently grouping sets of papers or documents is crucial to maintaining an organization of the documents. As such, holding the documents in a tight and organized manner is extremely important. Office supplies present different mechanisms to hold a group of documents together such as paper clips, staples and binder clips. Commonly, the user will simply hold the group of documents together and designate the documents with a note that adheres to the documents. Alternatively, users may mark the actual documents themselves with a handwritten note to indicate any necessary information about the documents.

A problem with holding the group of documents with these mechanisms, however, is being able to accurately and efficiently know what type of information the group of documents pertain as notes applied to the documents often become detached from the documents. Further, notes which are handwritten on the documents are commonly unclear or become unclear over time. A need, therefore, exists to accurately and clearly notify the user of any indicating information about the documents. The solution, however, must be capable of indicating the information without detaching from the documents. Further, the solution must be capable of indicating the information without marking the documents. Further, a need exists for an efficient way of economically and conveniently changing the information on the documents while still grouping the documents together.

Document holders currently available often apply only a clamping mechanism to hold the documents together without indicating any information of the documents. As such, these mechanisms fail to meet the current need. U.S. Pat. No. 4,506,416 issued to Ohminato discloses a paper clip. In the '416 patent, an arched movable member is connected to a bottom plate by a connector plate in which the documents are inserted between the movable member and the bottom plate. Thus, the connector plate pressures the arched movable member toward the bottom plate to hold the documents together. This paper clip, though, does not solve the current need, as the paper clip does not present any form of information as to the documents held by the paper clip. Accordingly, a user is required to attached a separate note which will likely detach from the documents. Or, the user is required to actually mark on the documents to indicate any necessary information. Further, the paper clip does not present any form of replaceable information capable of being applied to the documents held.

Another device, U.S. Pat. No. 4,011,673 issued to Levine discloses a bearing clip. In the '673 patent, a V-shaped clamping member is molded to a base member. The V-shaped clamping member is capable of bending up and away from the base member. Thus, the documents are inserted between the V-shaped clamping member and the base member and the documents are held by the clamping force of the V-shaped clamping member. The base member of the '673 patent comprises a lattice of perpendicular ridges where spacing between the ridges allows marking such as ink or pencil to settle between the ridges to indicate the desired indicia applied to the ridges.

This clip also does not solve the current need, as the V-shaped clamping member would not provide enough clamping force to hold the documents in a vertical position. Further, the markings would not be completely removable, as some of the ink would remain between the ridges resulting in an unclear identification of the documents.

### SUMMARY OF THE INVENTION

The present invention relates to a clip device, in particular, an indicia clip device that holds a group of documents configured to display indicia regarding the group of documents.

In an embodiment, the indicia clip device comprises a base member having a base engagement end and a base support end. At least one pivot member is further connected to the base member. The indicia clip device further comprises an indicia member having an indicia engagement end, an indicia support end and an indicia area. The indicia area is positioned above the base member where the indicia area is positioned to outwardly face opposite the base member.

A biasing element is connected to the at least one pivot member to biasing element the indicia engagement end toward the base engagement end to hold the group of documents. An indicia display is located on the indicia area wherein the indicia display is configured to receive and display interchangeable indicia.

In an embodiment, the indicia display has a transparent pocket and a tab which is slidably engaged within the transparent pocket. The tab is configured to present the indicia within the transparent pocket. Accordingly, the tab is configured to receive written matter or printed matter.

In an embodiment, the indicia display is located directly on the indicia member. Accordingly, the indicia display is configured to be erasable to receive and display interchangeable indicia directly on the indicia member.

In an embodiment, the indicia display is located on the indicia member. The indicia clip device further comprises a programmable storage device to electronically store the indicia. The indicia display comprises an electrical readout of the indicia. In an embodiment, the indicia display is a liquid crystal display.

An advantage of the present invention is to provide an indicia clip device that efficiently groups a set of documents.

Another advantage of the present invention is to provide indicia on the indicia clip device to indicate necessary information pertaining to the group of documents.

Another advantage of the present invention is to provide a convenient identification of the group of documents.

Still further advantages will become apparent from a consideration of the following descriptions and drawings.

### BRIEF DESCRIPTION OF THE DRAWINGS

FIG. 1 is a perspective view of an indicia device embodying the principles of the present invention.

FIG. 2 is another perspective view of the indicia device of FIG. 1 rotated 90 degrees.

FIG. 3 is a perspective view of a biasing element of FIG. 2.

FIG. 4 is a perspective view of another embodiment of the biasing element.

FIG. 5 is a front view of the indicia device of FIG. 1 in a first position.

FIG. 6 is a front view of the indicia device shown in FIG. 5 in a second position.

FIG. 7 is a plan view of the indicia device of FIG. 1.

FIG. 8 is side view of the indicia device of FIG. 1.

FIG. 9 is a perspective view of another embodiment of an indicia device embodying the principles of the present invention.

FIG. 10 is a perspective view of another embodiment of an indicia device embodying the principles of the present invention.

### DETAILED DESCRIPTION OF THE PREFERRED EMBODIMENTS

As discussed above, the present invention provides structures and other accommodations to display indicia indicating information of a set of documents while grouping the set of documents. The present invention efficiently and conveniently changes the indicia for the grouped documents.

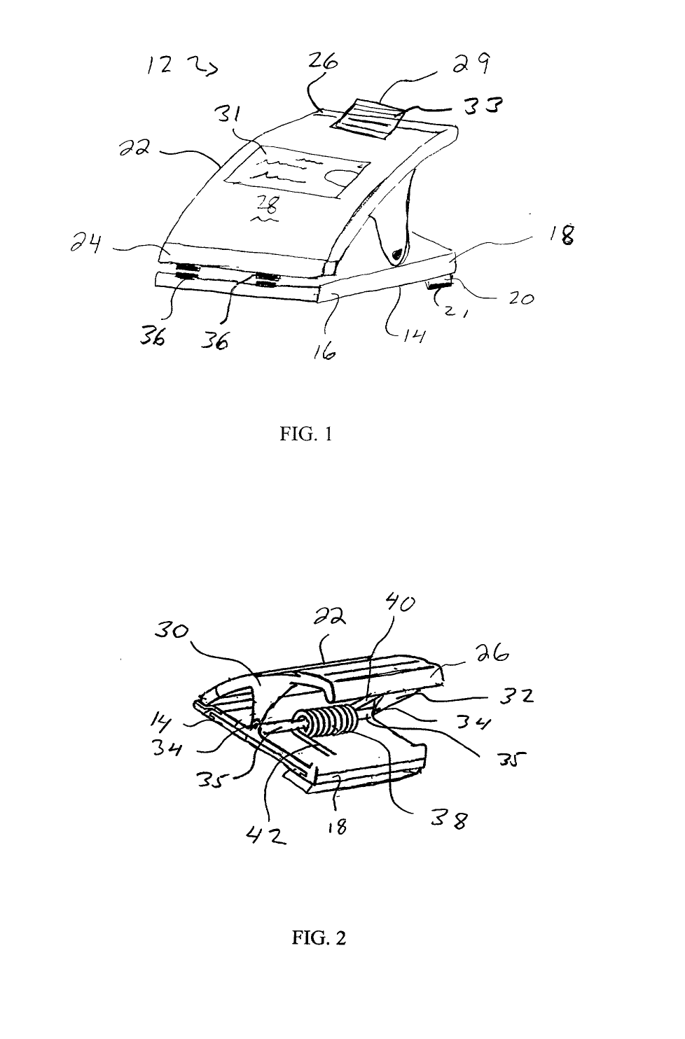

FIG. 1 illustrates a perspective view of an exemplary indicia clip device 12 to display indicia regarding documents in accordance with general principles of the invention. As shown in FIG. 1, the indicia clip device 12 includes a base member 14 that further has a base support end 18 adapted to support the indicia clip device 12. A support 20 is attached below the base support end 18 to conveniently angle the indicia clip device 12 toward the user. The support 20 may also act as a connecting point to attach a connector 21, such as, but not limited to, a magnet (not shown) or an adhesive. Accordingly, the indicia clip device may be attached by the support 20 to a vertical structure such as wall via the connector 21. The base member 14 also has a base engagement end 16 which is adapted to partially engage documents to hold the documents together.

Positioned above the base member 14 is an indicia member 22 having an indicia engagement end 24 and an indicia support end 26. An indicia area 28 is positioned between the indicia engagement end 24 and the indicia support end 26. Preferably, as shown in FIG. 1, the indicia member 22 is curved shaped to position the indicia area 28 to outwardly face from the base member 14. The curved shape of the indicia member 22 presents a better view angle of the indicia to the user. It should be known that other configurations such as straight may also be configured for the indicia member 22.

Additionally, a mount 29 is molded on the indicia support end 26 to allow the user to conveniently press down with a finger or thumb on the indicia member 22. The mount 29 further has ridges 33 to provide more friction against the finger or thumb of the user. The indicia clip device 12 further comprises a plurality of jaws 36 positioned on the base engagement end 16 and the indicia engagement end 24 to further facilitate holding the documents together. The plurality of jaws may be positioned opposite each other or may be positioned staggered from each other.

As shown in FIG. 1, located on the indicia area 28 is an indicia display 31 which is configured to receive and display interchangeable indicia which will be further explained below. The indicia display 31 may be attached to the indicia area 28 by accommodations known in the art such as an adhesive.

Turning to FIG. 2, in order to efficiently group the documents together between the base member 14 and indicia member 22, a biasing element 38 may be used. FIG. 2 depicts in perspective view an embodiment where the biasing element 38 is located between the base member 14 and the indicia member 22. In order to position the biasing element 38, at least one pivot member 34 is connected to the base member 14. Pivot arms 35 extend from the at least one pivot member 34 to connect the biasing element 38 to the pivot member 34.

As shown in FIG. 2, the biasing element 38, through the at least one pivot member 34, biases the indicia member 22 toward the base member 14. In order to move the indicia member 22 toward the base member 14, a first side 30 and a second side 32 of the indicia member 22 connect to the pivot member 34. The biasing element 38 shown in FIG. 2 further has an upper portion 40 which connects to the indicia member 22 under the indicia support end 26. The upper portion 40 applies the force of the biasing element 38 against the indicia member 22. Accordingly, the biasing element 38 has a lower portion 42 which connects to the base member 14 to apply the force of the biasing element 38 against the base member 14 near the base support end 18.

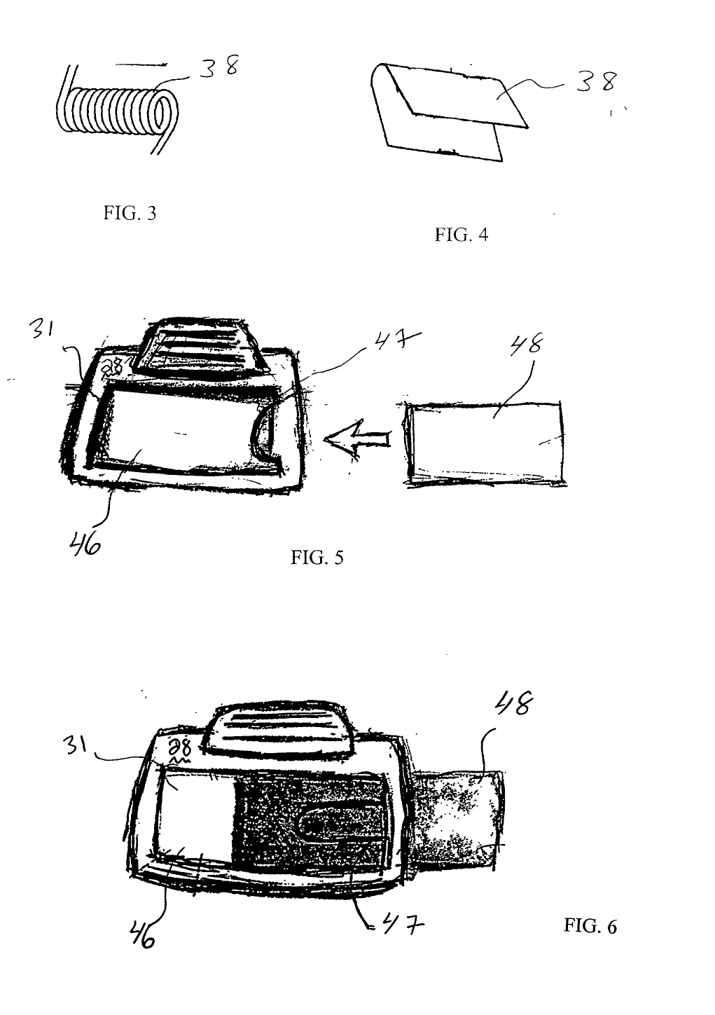

Turning to FIGS. 3 and 4, different types of biasing elements 38 are shown. FIG. 3 depicts a perspective view wherein a spring is used as the biasing element 38. Alternatively, a compression bracket may be used as the biasing element 38 as shown in FIG. 4. Other mechanisms known in the art may also be used as the biasing element 38.

Turning to FIGS. 5 and 6, as discussed previously, the indicia display 31 is configured to receive and display different types of indicia. In one embodiment, the indicia display 31 has a transparent pocket 46 which attaches to indicia area 28 by an adhesive. The indicia display 31 further has a tab 48 which is free to engage the transparent pocket 26 by sliding inside and outside the transparent pocket 46. To assist in sliding the tab 48, an arc 47 is positioned on the transparent pocket 46 which enables the user to easily grab and slide the tab 48 within the transparent pocket 46. The tab 48 comprises any type of material such as paper which indicia may be applied. Accordingly, the necessary indicia to identify the documents may be applied to the tab 48. Further, the tab 48 may be erasable to apply new indicia or another tab 48 with different indicia may inserted into the transparent pocket 46. Further, it should be noted that the tab 48 may be color coded to further identify the documents.

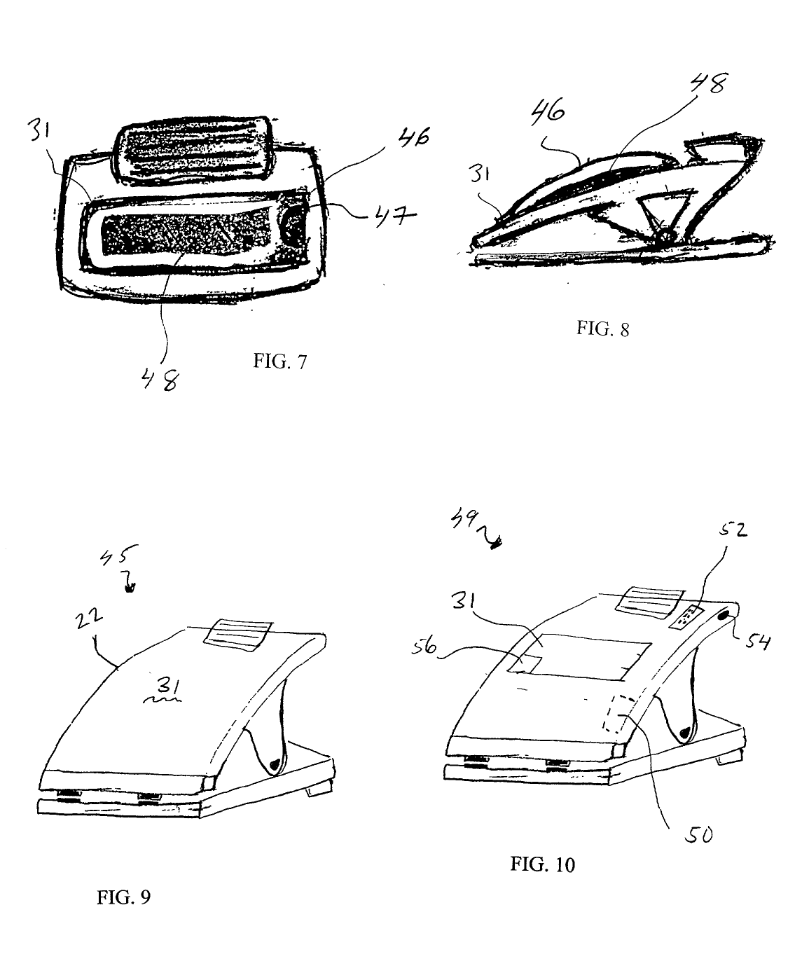

FIG. 5 illustrates the tab 48 positioned outside of the transparent pocket 46 while FIG. 6 illustrates the tab 48 partially engaged within the transparent pocket 46. Referring to FIG. 7, the tab 48 is shown engaged within the transparent cover 46 from a plan view. As the user can see through the transparent cover 46, the indicia of the tab 48 easily identifies the necessary information of the documents or items to the user. Turning to FIG. 8, the tab 48 is shown engaged within the transparent cover 46 from a side view.

During use, the user may group sets of documents or items in a particular arrangement or order. Once grouped, the tab 48 is marked with the necessary indicia in any appropriate manner such as but not limited to a handwritten, typed, or printed matter. Subsequent to marking, the tab 48 is inserted within the transparent pocket 46 to properly identify the grouped documents. The user then presses down on the mount 29 which activates the biasing element 38 to cause the indicia member 22 to open away from the base member 14. The documents are placed between the indicia member 22 and the base member 14 where the biasing element 38 then forces the indicia member 22 toward the base member 14 to properly hold the documents. The plurality of jaws 36 further facilitates the force of the biasing element 38 against the documents. The user then may replace the tab 48 with a new tab 48 with different indicia. Or, the user may remove the tab 48 to erase or delete the indicia and apply new indicia to the tab 48.

FIG. 9 depicts in perspective view another embodiment of the invention employing other principles of the invention generally shown as 45. As illustrated, the indicia display 31 of this embodiment is directly part of the indicia member 22. Accordingly, the indicia is directly applied on the indicia member 22. Thus, the indicia display 31 is comprised of material in which indicia may be applied and removed without permanently marking the indicia member 22. During use, the user may directly mark the indicia member 22 with the indicia to properly identify the grouped documents. Further, the user may erase the indicia to apply new indicia to the indicia member 22.

FIG. 10 depicts in perspective view another embodiment of the invention employing other principles of the invention generally shown as 49. As illustrated, the indicia display 31 comprises an electrical readout such as a liquid crystal display. The indicia clip device 49 of this embodiment further comprises a programmable storage device 50 such as a microprocessor to electronically store interchangeable indicia or information. The programmable storage device 50 may also comprise a transmitter and receiver as commonly known in the art to process the interchangeable indicia. Accordingly, the indicia or information may be transferred to and from an external device (not shown) such as a central processing unit. The indicia may be transferred to the external device via hardware (not shown) or a wireless link (not shown).

In order to process the interchangeable indicia into the programmable storage device 50, a portal 54 may be attached to the indicia clip device 49 to connect the hardware to the external device. Further, in order to scroll the indicia along the indicia display 31, a control pad 52 may be configured to the indicia clip device 49 to ascertain the indicia particularly needed. It should be known to those in the art that other forms of electrical communication such as wired or wireless links may also be used with the present invention. Further, the indicia clip device 49 may also have an recording mechanism 56 to record and play audible recordations.

During use, a user may process the interchangeable indicia from a central processing unit such as a personal computer and transmit the indicia to the programmable storage device 50 via the portal 54. Accordingly, the user may extract the indicia from the programmable storage device 50 to the central processing unit.

Once the indicia is stored on the programmable storage device 50, the indicia display 31 is capable of displaying the information to the observer. Further, the user may activate the control pad 52 to move the indicia within the indicia display 31. Further, instead of printing the indicia, the user may record the indicia on the recording mechanism 56. The user then may play the recorded indicia to identify the set of grouped documents.

Although the foregoing detailed description of the present invention has been described by reference to various embodiments, and the best mode contemplated for carrying out the prevention invention has been herein shown and described, it will be understood that modifications or variations in the structure and arrangement of these embodiments other than there specifically set forth herein may be achieved by those skilled in the art and that such modifications are to be considered as being within the overall scope of the present invention. Accordingly, the present invention is adapted for multiple shapes, sizes and colors.

I claim:

1. An indicia clip device, comprising:
a base member having a base engagement end, a base support end and at least one pivot member;
an indicia member having an indicia engagement end, an indicia support end and an indicia area, the indicia member positioned above the base member wherein the indicia area outwardly faces opposite the base member;
a biasing element connected to the at least one pivot member to biasing element the indicia engagement end toward the base engagement end; and
an indicia display located on the indicia area, the indicia display configured to receive and display interchangeable indicia.

2. The indicia clip device of claim 1, wherein the indicia display has a transparent pocket and tab, the tab being slidably engageable within the pocket.

3. The indicia clip device of claim 1, further comprising a plurality of jaws attached to the base engagement end and the indicia engagement end.

4. The indicia clip device of claim 1, further comprising a mount molded to the indicia support end.

5. The indicia clip device of claim 1, further comprising a support attached to the base support end.

6. The indicia clip device of claim 5, wherein the support has a connector.

7. The indicia clip of claim 1, wherein the indicia display is connected to the indicia area by an adhesive.

8. The indicia clip device of claim 1, wherein the indicia member is curve shaped.

9. The indicia clip device of claim 1, wherein the biasing element is a spring.

10. The indicia clip device of claim 1, wherein the biasing element is a compression bracket.

11. The indicia clip device of claim 1, wherein the tab is configured to be erasable.

12. An indicia clip device, comprising:
a base member having a base engagement end, a base support end and at least one pivot member;
a curved indicia member having an indicia engagement end, an indicia support end, an indicia area and a mount, the curved indicia member positioned above the base member wherein the indicia area is positioned below the mount;
a plurality of biasing elements connected to the at least one pivot member to biasing element the indicia engagement end toward the base engagement end; and
an indicia display located on the indicia member, the indicia display configured to be erasable to receive and display interchangeable indicia.

13. The indicia clip of claim 12, further comprising a plurality of jaws attached to the base engagement end and the indicia engagement end.

14. The indicia clip of claim 12, further comprising a support attached to the base support end.

15. The indicia clip device of claim 12, wherein the plurality of biasing elements are springs.

16. The indicia clip device of claim 12, wherein the plurality of biasing elements are compression brackets.

17. An indicia clip device, comprising:
a base member having a base engagement end, a base support end and at least one pivot member;
an indicia member having an indicia engagement end, an indicia support end and an indicia area, the indicia member positioned above the base member wherein the indicia member outwardly faces opposite the base member;
a biasing element connected to the at least one pivot member to biasing element the indicia engagement end toward the base engagement end;
an indicia display located on the indicia area, the indicia display configured to receive and display interchangeable indicia; and
a storage device configured to electronically store the interchangeable indicia.

18. The indicia clip device of claim 17, wherein the storage device comprises a microprocessor to transmit and receive the interchangeable indicia.

19. The indicia clip device of claim 18, wherein the storage device comprises a receiver and transmitter.

20. The indicia clip device of claim 17, wherein the indicia display is a liquid crystal display.

21. The indicia clip device of claim 17, wherein the indicia display is configured to emit an audible recording.
